(19) United States
(12) Patent Application Publication
(10) Pub. No.: US 2026/0166885 A1
(43) Pub. Date: Jun. 18, 2026

(54) INK STORAGE CONTAINER AND METHOD FOR MANUFACTURING INK STORAGE CONTAINER

(71) Applicant: CANON KABUSHIKI KAISHA, Tokyo (JP)

(72) Inventors: TAKANORI YASHIRO, Kanagawa (JP); DAISUKE NAKAGAWA, Kanagawa (JP)

(21) Appl. No.: 19/412,206

(22) Filed: Dec. 8, 2025

(30) Foreign Application Priority Data
Dec. 13, 2024 (JP) 2024-218848

(51) Int. Cl. B41J 2/175

(52) U.S. Cl. CPC B41J 2/17523; B41J 2/17553; B41J 2/17559

(57) ABSTRACT

An ink storage container of the present disclosure is an ink storage container for supplying ink to an ink ejection apparatus, including: an ink storage portion for storing the ink; and a pouring portion for pouring the ink stored in the ink storage portion, the ink storage portion having (a) a first region, a second region, and a main body region sandwiched between the first region and the second region, (b) the first region and the main body region, or (c) the second region and the main body region, wherein the main body region contains a first biomass-derived resin, and the first region and the second region are made of a second fossil fuel-derived resin. The technology of the present disclosure can contribute to the realization of a sustainable society, such as a decarbonized/recycling society.

### BACKGROUND

### Field of the Technology

The present disclosure relates to an ink storage container used in an ink ejection apparatus and a method for manufacturing the ink storage container.

### Description of the Related Art

Inkjet printing apparatuses are known as ink ejection apparatuses that perform printing by ejecting ink. In an inkjet printing apparatus, micro-droplets of ink are ejected from an inkjet printing head, which serves as a liquid ejection unit, to form and print characters and images on a printing medium. Such an inkjet printing apparatus is used for domestic purposes, office equipment or the like, and also in widespread use for industrial application. A storage container for ink that is to be used as a printing material for the inkjet printing apparatus is used to replenish the ink through an inlet for injecting the ink provided in the inkjet printing apparatus. Ink storage containers are made mostly from fossil fuel-derived plastic materials.

Product development for reducing the burden on the global environment has become a requirement in all industries involved in the development, production, and sale of products. Recycling and reuse have been adopted to reduce environmental burden of all liquid storage containers, including ink storage containers. Another method for reducing the environmental burden is changing a material used to manufacture the liquid storage containers from fossil fuel-derived plastic materials to environmentally friendly materials. Examples of such environmentally friendly materials include biomass plastics made from biological resources such as plants, biodegradable plastics, paper materials, and the like. In this way, there have been attempts made to reduce the use of fossil fuel-derived plastic materials.

One method for reducing the burden on the global environment is to replace the fossil fuel-derived plastic materials used for ink storage containers with biomass plastics. However, some alternative biomass plastic materials are not strong enough to withstand the impact when an ink storage container might fall from a vertical height. Therefore, if a user of the ink storage container accidentally drops the ink storage container, the possibility of damage to the ink storage container is to be reduced.

In this regard, manufacture of fossil fuel-derived plastic materials requires various forms of energy, from oil extraction to manufacture of plastics, processing into products, incineration upon disposal of the materials, and the like. These processes also emit a large amount of carbon dioxide. In contrast, biomass plastics are made mainly from plants, and carbon dioxide is absorbed through photosynthesis during cultivation of the plants. Therefore, even if carbon dioxide is emitted during the manufacture, disposal, and incineration of biomass plastics, the total amount of carbon dioxide emitted over the lifetime of the biomass plastics can be reduced to almost zero.

To reduce the burden on the global environment, the fossil fuel-derived plastic materials used for ink storage containers may be replaced with biomass plastics. In such cases, an attempt to obtain biomass plastics inexpensively would end up using biomass plastics or the like manufactured through mechanical recycling. However, some biomass plastics manufactured through mechanical recycling do not have the strength properties required for ink storage containers. Some organisms used as raw materials for biomass plastics do not have the strength properties required for use as ink storage containers. If a user of an ink storage container accidentally drops the ink storage container with a liquid still inside the container, the center of gravity of the container may cause the top or bottom of the ink storage container to easily hit the ground, potentially damaging the ink storage container, and there is a need to reduce the possibility of damage to the top or bottom of the ink storage container, recognizing that previously disclosed ink storage containers lacking strength.

Industries involved in the development, production, and sale of various products are required to reduce the burden on the global environment. Recycling and reuse have heretofore been adopted to reduce environmental burden of all liquid storage containers, including ink storage containers. There has also recently been a demand for the use of environmentally friendly materials in place of fossil fuel-derived plastic materials.

Japanese Patent Laid-Open No. 2022-110675 (Patent Document 1) discusses an ink storage container for providing an environmentally friendly ink storage container. Patent Document 1 proposes that at least some of the components of the ink storage container be made from a material containing an environmentally friendly resin.

### SUMMARY

In a case of using an ink storage container made of an environmentally friendly material with poor strength, it is required that the ink storage container maintains its strength against impacts such as fall. The present disclosure is directed to improve the strength of the ink storage container against impacts such as fall of the ink storage container.

An aspect of the present disclosure provides an ink storage container for supplying ink to an ink ejection apparatus, the ink storage container, including a storage portion and a pouring portion for pouring ink stored in the storage portion. The ink storage portion includes at least one of (a) a first region, a second region, and a main body region, with the main body region sandwiched between the first region and the second region, (b) the first region and the main body region, or (c) the second region and the main body region. The main body region contains a first resin derived from biomass. The first region and the second region are made of a second resin derived from fossil fuel.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view showing an inkjet printing apparatus in a state where a liquid is being replenished from an ink storage container;

FIG. 2 is a side view showing an ink storage container according to a first embodiment;

FIG. 3 is a side view showing the ink storage container according to the first embodiment;

FIG. 4 is a side view showing an ink storage container according to a second embodiment;

FIG. 5 is a side view showing the ink storage container according to the second embodiment;

FIG. 6 is a side view showing an ink storage container according to a third embodiment;

FIG. 7 is a side view showing the ink storage container according to the third embodiment;

FIG. 8 is a side view showing an ink storage container according to a fourth embodiment; and

FIG. 9 is a side view showing the ink storage container according to the fourth embodiment.

### DESCRIPTION OF THE EMBODIMENTS

The present disclosure relates to an ink storage container, and more particularly relates to an ink storage container with improved strength against impacts such as fall of the ink storage container. The present disclosure also relates to a method for manufacturing such an ink storage container.

The present disclosure will be described below with reference to the drawings.

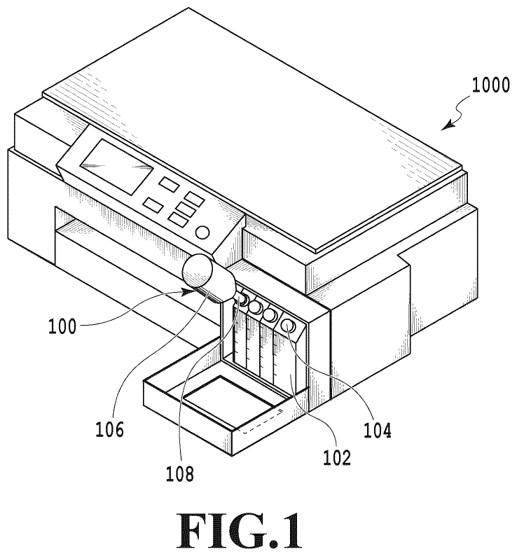

FIG. 1 is a perspective view showing an inkjet printing apparatus according to embodiments of the present disclosure in a state where the inkjet printing apparatus is replenished with liquid ink.

The inkjet printing apparatus performs printing by ejecting ink onto a printing medium while reciprocally moving a printing head in a direction orthogonal to a conveyance direction of the printing medium. As shown in FIG. 1, the inkjet printing apparatus includes an ink tank that stores ink, and ink may be supplied to the ink tank from an ink storage container. In this type of inkjet printing apparatus, a desired color of ink is injected or replenished from an ink storage container 100 to an ink tank 102. To replenish the ink, a user of an inkjet printing apparatus 1000 positions the ink storage container 100 to fill the ink through an ink introducing port 104 of the ink tank. For example, the ink storage container 100 has an ink storage portion 106 and an ink pouring portion 108. The ink pouring portion 108 has a spout for pouring the ink stored in the ink storage portion 106 to the outside.

As shown in FIG. 1, to replenish the inkjet printing apparatus 1000 with ink, the user inserts the spout of the ink storage container 100 into the introducing port 104 provided in the inkjet printing apparatus for injecting ink. Next, the user lifts the ink storage container 100 by hand and tilts the spout of the ink storage container downward (i.e., toward the ground). Tilting the ink storage container 100 downward allow the ink stored in the ink storage portion 106 to move toward the spout by gravity. The ink moves from the spout into the ink tank 102 of the inkjet printing apparatus 1000 through the ink introducing port 104 provided in the inkjet printing apparatus 1000 to replenish the ink tank 102 of the inkjet printing apparatus 1000.

The present disclosure relates to the ink storage container 100, as described above.

Embodiments of the ink storage container 100 of the present disclosure will be described below with reference to the drawings. The embodiments described below are intended to illustrate examples of the present disclosure and are not intended to limit the scope of the present disclosure to these embodiments. Unless otherwise specified, the dimensions, shapes, numbers, materials, and the like of various components in each of the following embodiments can be changed as appropriate within the scope of the present disclosure.

### First Embodiment

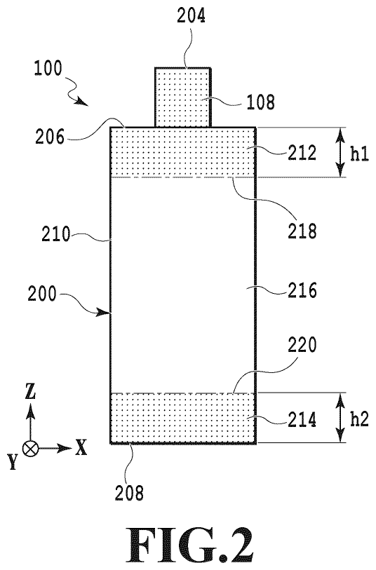

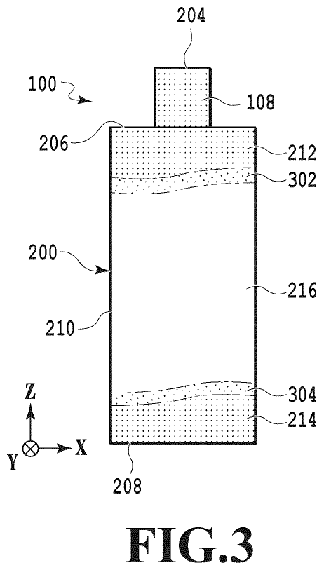

FIGS. 2 and 3 are side views showing an ink storage container 100 according to the first embodiment of the present disclosure.

As shown in FIG. 2, the ink storage container 100 has an ink storage portion 200 for storing ink containing a color material, solvent, surfactant, water, and the like, and an ink pouring portion 108. The ink pouring portion 108 has a spout 204 for pouring the ink stored in the ink storage portion 200 to the outside. Although not shown in FIG. 2, the ink storage container 100 is equipped with a separate, detachable cap that covers the spout 204. This cap prevents ink leakage except upon replenishing the ink from the ink storage container 100. The material used for this cap is not particularly limited. In other words, any known material can be used for the cap.

The ink storage container 100 has a first end portion 206 and a second end portion 208 in the ink storage portion 200. The first end portion 206 and the second end portion 208 of the ink storage container are provided on opposite ends of the ink storage portion 200. The ink pouring portion 108 of the ink storage container 100 is provided at the first end portion 206. In the present disclosure, the end portion of the ink storage portion having the ink pouring portion 108 is referred to as the first end portion 206 (see FIGS. 2-9), and the end portion opposite to the end portion of the ink storage portion having the ink pouring portion 108 is referred to as the second end portion 208 (see FIGS. 2-9).

The ink storage portion 200 has an ink storage portion side region 210 (also simply referred to as the side region in the present disclosure) that extends between the first end portion 206 and the second end portion 208.

The shape of the ink storage portion 200 of the ink storage container is not particularly limited, and may be any known shape for ink storage containers.

As illustrated in FIGS. 2-3, the ink storage container 100 has a first region 212 and a second region 214 that extend from the first end portion 206 and the second end portion 208, respectively, over certain respective ranges within the ink storage portion 200. The ink storage portion 200 also has an ink storage portion main body region 216 (referred to as the main body region in the present disclosure) sandwiched between the first region 212 and the second region 214. The first region 212 and the second region 214 are separated from the main body region 216 by respective boundaries 218 and 220.

In the description referring to the ink storage container of the present disclosure, in a case where the ink storage container is disposed with the ink pouring portion 108 of the ink storage container directed in an upward direction (see, for example, FIG. 2), the direction of the ink storage container is referred to as “upper” or “upward” direction. In the case where the ink storage container is disposed with the ink pouring portion 108 of the ink storage container directed in the downward direction, the direction toward the second end portion of the ink storage container 100 (the direction opposite to the direction where the ink pouring portion 108 is located) is referred to as “lower” or “downward” direction. In the present disclosure, in a configuration having the first end portion side facing the upward direction, the side including the first end portion may be referred to as the upper side. Similarly, in the present disclosure, in a configuration having the second end portion side facing the downward direction, the side including the second end portion may be referred to as the lower side.

### <Configuration of Ink Storage Container>

Each of the regions of the ink storage container will be described below.

The first region 212 of the ink storage container of the present disclosure is a given region from the first end portion (end portion of the ink storage portion having the ink pouring portion 108) toward inside the ink storage portion side region (inside the main body region). The second region 214 is a given region from the second end portion (end portion opposite to the end portion of the ink storage portion having the ink pouring portion 108) toward inside the ink storage portion side region (inside the main body region).

The first and second regions will be described in more detail with reference to FIG. 2. The first region 212 refers to a given region from the first end portion 206 toward the second end portion (portion having a height indicated by h1 in FIG. 2). In the present embodiment, the first region 212 can have the height (h1) of less than or equal to 45% of the total height of the ink storage portion 200, i.e., the height of the ink storage portion side region 210 (height from the first end portion 206 to the second end portion 208). In an embodiment, this height (h1) may be in the range of more than or equal to 0.5% and less than or equal to 45%. The second region 214 refers to a given region from the second end portion 208 toward the first end portion (portion having a height indicated by h2 in FIG. 2). In the present embodiment, the second region 214 can have the height (h2) of less than or equal to 45% of the total height of the ink storage portion 200, i.e., the height of the ink storage portion side region 210 (height from the first end portion 206 to the second end portion 208). In an embodiment, this height (h2) may be in the range of more than or equal to 0.5% and less than or equal to 45%. The first region 212 can have a height of more than or equal to 10% and less than or equal to 25% of the total height of the ink storage portion 200, measured from the first end portion. The second region 214 can have a height of more than or equal to 10% and less than or equal to 25% of the total height of the ink storage portion 200, measured from the second end portion.

The shape of the first region 212 is not particularly limited, but can be a rectangular shape with an equal height from the first end portion 206 as seen from the side of the ink storage container, as shown in FIG. 2, for example. Similarly, the shape of the second region 214 is not particularly limited, and can be a rectangular shape with an equal height from the second end portion 208 as seen from the side of the ink storage container, as shown in FIG. 2, for example. If the first and second regions do not have the rectangular shape, the above heights of these regions are set to the average of the shortest and longest lengths from the first end portion or the second end portion.

The ink storage container 100 of the present disclosure is formed of a resin material, e.g., plastic. In the ink storage container 100 of the present disclosure, the first region 212 and the second region 214 include a fossil fuel-derived resin. Examples of the fossil fuel-derived resin that can be used for the ink storage container 100 of the present disclosure include polyolefin such as polyethylene (PE), polypropylene (PP), and polystyrene (PS). Other usable fossil fuel-derived resins include polyester (PEs) such as polyethylene terephthalate (PET). The combination of the above resins can be used as a material for ink storage container of the present disclosure.

In the present embodiment, the main body region 216 is sandwiched between the first region 212 and the second region 214 of the ink storage portion 200, as shown in FIG. 2. The main body region 216 is distinguished from the first and second regions by the boundary 218 with the first region and the boundary 220 with the second region.

The main body region 216 includes a biologically derived resin, that is, a biomass-derived resin. Examples of the biomass-derived resin include biomass polyolefin such as biomass polyethylene, biomass polypropylene, and biomass polystyrene. Other usable biomass-derived resins include biomass polyester such as biomass polyethylene terephthalate. The biomass-derived resin usable for the ink storage container of the present disclosure can be a combination of the above-mentioned resins. The biomass resin usable in the present disclosure includes the biomass-derived resin described above as a main component. In the main body region of the ink storage container 100 of the present disclosure, the term “main component” refers to the range of the content of the biomass-derived resin described above in the main body region 216. In other words, the main body region 216 may contain a fossil fuel-derived resin in addition to the biomass-derived resin as the main component. The content of the biomass-derived resin in the main body region 216 can be 100 mass %, based on the total mass of the main body region 216. In an embodiment, the content of the biomass-derived resin may be more than or equal to 60 mass % and less than or equal to 99 mass %, based on the total mass of the main body region 216. In the ink storage container 100 of the present disclosure, the content of the biomass-derived resin can be more than or equal to 10 mass %, based on the total mass of the ink storage container 100. In a case where the main body region 216 contains a fossil fuel-derived resin, the combination of these resins is not particularly limited. However, in an embodiment, the same type of fossil fuel-derived resin as the biomass-derived resin can be used, in terms of compatibility, mechanical characteristics, and the like. For example, if the biomass-derived resin is biomass polyolefin (e.g., biomass polyethylene), polyolefin (e.g., polyethylene) can be used as the fossil fuel-derived resin.

In the ink storage container of the present disclosure, as described above, the fossil fuel-derived resin is used for the first region 212 and the second region 214, and a resin including biomass-derived resin as a main component is used for the main body region 216. The fossil fuel-derived resin used for the ink storage container of the present disclosure has higher rigidity than the biomass-derived resin. Specifically, the fossil fuel-derived resin has higher physical properties, such as Izod impact strength and Charpy impact strength at room temperature (more than or equal to 23° C. and less than or equal to 25° C.), than the biomass-derived resin. The Charpy impact strength of the fossil fuel-derived resin can be in the range of more than or equal to 7 kJ/m² and less than or equal to 25 kJ/m². On the other hand, the Charpy impact strength of the biomass-derived resin can be in the range of more than or equal to 2 kJ/m² and less than or equal to 15 kJ/m². Depending on the required specifications within the same range, the fossil fuel-derived resin is selected so that its Charpy impact strength is higher than that of the biomass-derived resin. For example, polyethylene having the Charpy impact strength of 17 kJ/m² and biomass polyethylene having the Charpy impact strength of 10 kJ/m² can be used. In the ink storage container of the present disclosure, the fossil fuel-derived resin used for the first and second regions can consist of a fossil fuel-derived resin (the term “consisting of” encompasses consisting solely of a fossil fuel-derived resin), as long as the resin has the above-mentioned strength.

In the present disclosure, either the fossil fuel-derived resin or the biomass-derived resin can be colored. Alternatively, both of these resins may be colored in different colors, allowing the first and second regions containing the respective resins to be visually distinguishable from the main body region. In the present disclosure, the fossil fuel-derived resin or the biomass-derived resin may be colored, and compatible portions 302 and 304 may be colored, allowing the first and second regions to be visually distinguishable from the main body region.

The ink pouring portion 108 having the ink spout 204 is provided at the first end portion 206 of the ink storage portion 200. As with the ink storage portion 200, the ink pouring portion 108 can be formed integrally with the ink storage portion 200, using a fossil fuel-derived resin. Alternatively, the ink pouring portion 108 can be a separate component from the ink storage portion 200. The ink pouring portion 108 can also have a spout-like shape and function. The characteristics of the spout of the ink pouring portion 108, such as the shape and size, are not particularly limited as long as ink can be introduced into the ink tank of the inkjet printing apparatus. Any commonly used configuration may be employed.

### <Method for Manufacturing Ink Storage Container>

A method for manufacturing an ink storage container of the present disclosure will be described below.

A method for forming the ink storage portion 200 of the ink storage container 100 will be described below. The ink storage container 100 of the present disclosure includes forming the ink storage portion 200 and the ink pouring portion 108. In the present embodiment, forming the ink storage portion 106 includes forming a main body region 216, a first region 212, and a second region 214.

The ink storage portion 200 can be formed by a method such as two-color molding using blow molding, welding using heat, laser or ultrasound, or bonding using an adhesive. The method for forming the ink storage portion 200 is not particularly limited, and any known method other than those described above may be used.

In a case of forming the ink storage portion 200 by two-color molding using blow molding, a compatible portion including a fossil fuel-derived resin and a biomass-derived resin may be formed. For example, as shown in FIG. 3, the ink storage portion 200 may have the compatible portions 302 and 304 formed by two-color molding. The compatible portions 302 and 304 correspond to the boundary 218 between the first region 212 and the main body region 216 and the boundary 220 between the second region 214 and the main body region 216, respectively. The region and shape of these compatible portions are not particularly limited and can be set according to molding conditions of the two-color molding. In FIG. 3, the compatible portions 302 and 304, as well as the first region 212 and the second region 214, are illustrated as having a wavy shape at the boundaries with the main body region 216. However, the ink storage container 100 of the present disclosure is not limited to such wavy shape. Any shape may be used as long as the first region 212 and the second region 214 can be distinguished from the main body region 216 and can be cut and separated upon collection of the container.

As described above, the first region 212 and the second region 214 of the ink storage portion 200 are comprised of a fossil fuel-derived resin, and the main body region 216 is comprised of a resin that a biomass-derived resin is a main component. From the perspective of the manufacturing method, the same type of resin may be used for these resins. Specifically, if polyolefin (for example, polyethylene) is used as the fossil fuel-derived resin, biomass polyolefin (for example, biomass polyethylene) can be used as the biomass-derived resin.

As described above, the ink storage container of the present disclosure may have a configuration in which the first and second regions are visually distinguishable from the main body region, using a material obtained by coloring at least one of the fossil fuel-derived resin and the biomass-derived resin. The ink storage container with such visual distinction can be prepared by two-color molding of a resin obtained by coloring at least one of the fossil fuel-derived resin and the biomass-derived resin using a two-color molding method.

The ink pouring portion 108 having the ink spout 204 can be formed integrally with the ink storage portion 200, or may be formed as a separate component from the ink storage portion 200. In a case of forming the ink pouring portion 108 as a separate component, the ink pouring portion 108 is formed and then joined to the ink storage portion 200. Examples of a joining method include mechanical joining such as screwing and fitting, joining by insert molding, welding using heat or laser, bonding using an adhesive, and the like.

The fossil fuel-derived resin used for the ink storage container of the present disclosure has higher rigidity than the biomass-derived resin. Specifically, the fossil fuel-derived resin has higher physical properties, such as Izod impact strength and Charpy impact strength at room temperature (more than or equal to 23° C. and less than or equal to 25° C.), than the biomass-derived resin. The Charpy impact strength of the fossil fuel-derived resin is as described above. For example, the ink storage container of the present disclosure was manufactured using the previously mentioned polyethylene with the Charpy impact strength of 17 kJ/m² and biomass polyethylene with the Charpy impact strength of 10 kJ/m².

As described above, in the ink storage container 100 of the present disclosure, the first region 212 and the second region 214 are formed of a fossil fuel-derived resin having higher strength than the main body region. On the other hand, the main body region 216 sandwiched between the first region 212 and the second region 214 is formed of a biomass-derived resin, the main body 216 having a lower strength than the first region 212 and the second region 214. If the user accidentally drops the ink storage container with a liquid still in the container, the center of gravity causes the second end portion side or first end portion side of the container to easily hit the ground. In addition, the first region 212 on the first end portion side of the ink storage container 100 and the second region 214 on the second end portion side thereof are formed of a fossil fuel-derived resin having higher strength than the biomass-derived resin of the main body region 216. Therefore, in a case where the ink storage container 100 falls with the first end portion side 206 or the second end portion side 208 striking the ground first, forming the first end portion side 206 or the second end portion side 208 from strong fossil fuel-derived resin reduces the possibility of damage to the ink storage container 100 due to the impact of the fall. Meanwhile, the main body region 216 of the ink storage container 100 is formed of a biomass-derived resin, which can reduce the amount of carbon dioxide generated over its lifetime to plus/minus near zero. The ink storage container 100 of the present disclosure can be configured so that the first region 212 and the second region 214 can be distinguished from the main body region 216. Therefore, upon collection of the ink storage container 100 by a manufacturer, the first region 212 and the second region 214 can be cut off separately from the main body region 216, thereby allowing the fossil fuel-derived resin and the biomass-derived resin to be collected separately for reuse. In the ink storage container 100 of the present disclosure, as described above, either the fossil fuel-derived resin or the biomass-derived resin can be colored, or these resins can be colored in different colors. This makes it easier to determine the type of resin. In this way, the environmental burden can be reduced to contribute to the realization of a sustainable society, such as a decarbonized/recycling society.

### Second Embodiment

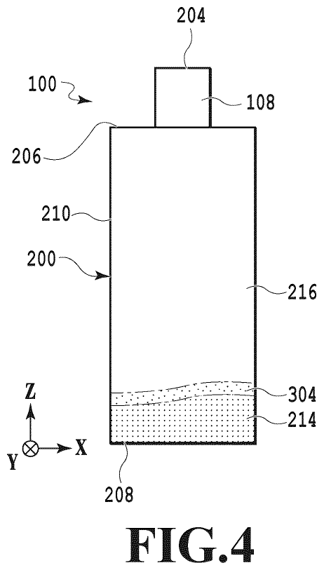

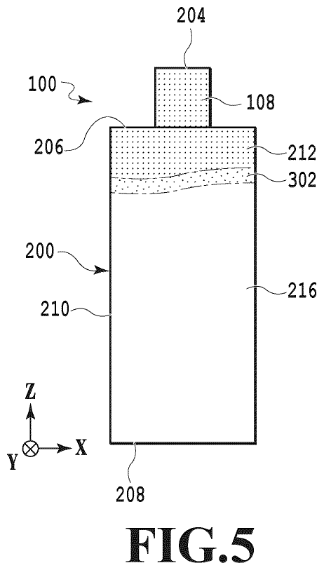

A second embodiment will be described with reference to FIGS. 4 and 5.

FIGS. 4 and 5 are side views showing an ink storage container 100 according to an embodiment of the present disclosure.

In the present embodiment shown in FIGS. 4 and 5, either a first region 212 or a second region 214 of an ink storage container 100 exists in an ink storage portion 200. The remaining portion of the ink storage portion 200 serves as a main body region 216. As for the ink storage portion of the present embodiment, the first region 212 or the second region 214 is formed of a fossil fuel-derived resin, and the remaining main body region 216 is formed of a material containing a biomass-derived resin mainly. On the other hand, in the embodiment shown in FIGS. 2 and 3, both the first region 212 and the second region 214 of the ink storage container 100 exist in the ink storage portion 200, and are formed of a fossil fuel-derived resin. In contrast to the first embodiment, the main body region 216 is located between the first region 212 and the second region 214, and is formed of a material containing a biomass-derived resin.

A first example of the second embodiment is an ink storage container shown in FIG. 4. In this example, the ink storage container 100 has the ink storage portion 200 including the main body region 216 and the second region 214. In the embodiment shown in FIG. 4, the first region 212 is not provided, and the main body region 216 of the ink storage portion 200 starts from the first end portion 206. In the first example, the second region 214 can have a height of less than or equal to 45% of the total height of the ink storage portion 200 (the height from the first end portion 206 to the second end portion 208) as measured from the second end portion. In an embodiment, the second region 214 can have a height of more than or equal to 0.5% and less than or equal to 45% of the total height of the ink storage portion 200 as measured from the second end portion. The shapes, characteristics, and the like of other regions in the first example are as described in the first embodiment. While FIG. 4 illustrates a configuration having a compatible portion 304, the ink storage container 100 of the present disclosure is not limited to this configuration.

A second example of the second embodiment is an ink storage container 100 shown in FIG. 5. In this example, the ink storage container 100 has an ink storage portion 200 including a main body region 216 and a first region 212. In the present embodiment shown in FIG. 5, the second region 214 is not provided, and the main body region 216 of the ink storage portion extends from the boundary of the first region 212 toward the second end portion. In the second example, the first region 212 can have a height of less than or equal to 45% of the total height of the ink storage portion 200 (the height from the first end portion 206 to the second end portion 208) as measured from the first end portion. In an embodiment, the first region 212 may have a height of more than or equal to 0.5% and less than or equal to 45% of the total height of the ink storage portion 200 as measured from the first end portion. The shapes, characteristics, and the like of other regions in the second example are as described in the first embodiment. While FIG. 5 illustrates a configuration having a single compatible portion 302, the ink storage container 100 of the present disclosure is not limited to this configuration.

The above-described configuration can improve the strength of either the first end portion side or the second end portion side of the ink storage container 100. In addition, the amount of biomass-derived resin used in the ink storage container 100 can be increased. As a result, the environmental burden can be further reduced.

A method for manufacturing an ink storage container in the second embodiment is the same as the method for manufacturing an ink storage container in the first embodiment, except that either the first region or the second region is formed in the ink storage portion, and description of such methods is incorporated herein by reference.

The other configurations and effects of the present embodiment are the same as those of the first embodiment, and description is incorporated herein by reference.

### Third Embodiment

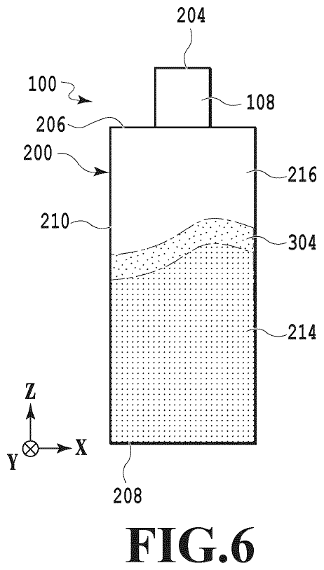

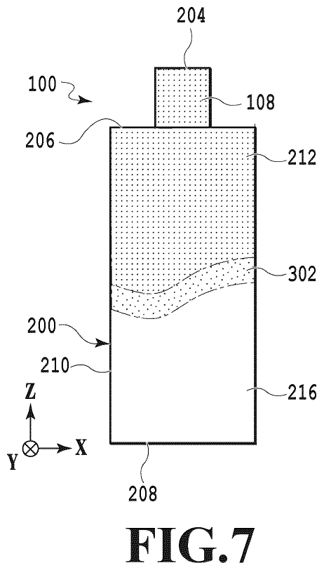

A third embodiment will be described with reference to FIGS. 6 and 7. The present embodiment is a modification of the second embodiment.

FIGS. 6 and 7 are side views showing an ink storage container 100 according to the third embodiment of the present disclosure.

In the present embodiment shown in FIGS. 6 and 7, as in the case of the ink storage container 100 of the second embodiment, either a first region 212 or a second region 214 of an ink storage container 100 exists in an ink storage portion 200. The remaining portion of the ink storage portion 200 serves as a main body region 216. In contrast to the first embodiment, the first region 212 or the second region 214 is formed of a fossil fuel-derived resin, and the remaining main body region 216 is formed of a material containing a biomass-derived resin mainly.

A first example of the third embodiment is an ink storage container 100 shown in FIG. 6. In this example, an ink storage container 100 has an ink storage portion 200 including a main body region 216 and a second region 214. In the present embodiment shown in FIG. 6, the first region 212 is not provided, and the main body region 216 of the ink storage portion starts from the first end portion 206. In the first example of the present embodiment, the second region 214 can have a height of more than or equal to 50% of the total height of the ink storage portion 200 (the height from the first end portion 206 to the second end portion 208). In an embodiment, the second region 214 may have a height of more than or equal to 50% and less than or equal to 90% of the total height of the ink storage portion 200. The shapes, characteristics, and the like of other regions in the first example of the present embodiment are as described in the first embodiment. While FIG. 6 illustrates a configuration having a compatible portion 304, the ink storage container 100 of the present disclosure is not limited to this configuration.

A second example of the third embodiment is an ink storage container 100 shown in FIG. 7. In this example, the ink storage container 100 has an ink storage portion 200 including a main body region 216 and a first region 212. In the present embodiment shown in FIG. 7, the second region 214 is not provided, and the main body region 216 of the ink storage portion 200 extends from the boundary of the first region 212 toward the second end portion. In the second example of the present embodiment, the first region 212 can have a height of more than or equal to 50% of the total height of the ink storage portion 200 (the height from the second end portion 208 to the boundary with the first region). In an embodiment, the first region 212 may have a height of 50% to 90% of the total height of the ink storage portion 200. The shapes, characteristics, and the like of other regions in the second example of the present embodiment are as described in the first embodiment. While FIG. 7 illustrates a configuration having a single compatible portion 302, the ink storage container 100 of the present disclosure is not limited to this configuration.

In terms of the strength, the above-described configuration can improve the strength of either the first end portion side or the second end portion side of the ink storage container 100. In addition, with the above configuration, the first or second region of the ink storage container 100 can account for more than or equal to 50% of the ink storage portion 200. In an embodiment, the first or second region of the ink storage container 100 may account for more than or equal to 50% and less than or equal to 90% (more than half). This allows a large portion of the ink storage portion 200 to be formed of a fossil fuel-derived resin. As a result, the strength of the first or second region can be specifically improved, compared to the first embodiment. The above configuration can reduce the possibility of damage to the ink storage container 100 due to impacts such as accidental fall of the ink storage container 100 or blow from the direction of the side region 210 (from the side direction).

A method for manufacturing an ink storage container in the third embodiment is the same as the method for manufacturing an ink storage container in the first embodiment, except for forming either the first region or the second region in the ink storage portion, and description of such methods is incorporated herein by reference.

The other configurations and effects of the present embodiment are the same as those of the first embodiment, and description is incorporated herein by reference.

### Fourth Embodiment

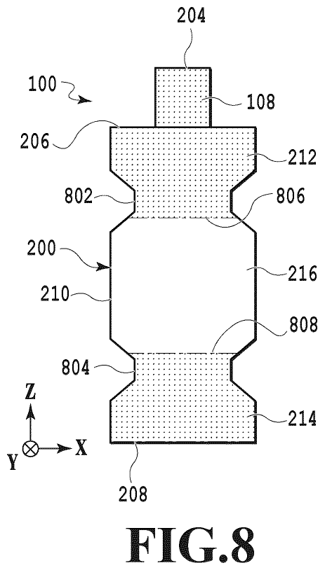

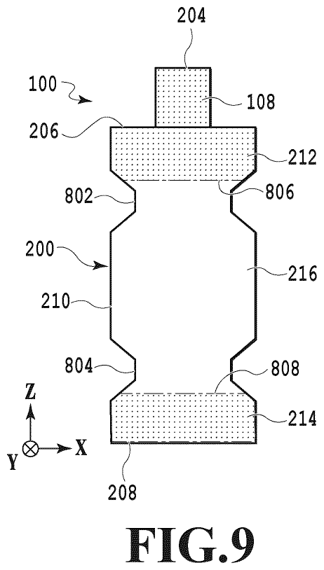

A fourth embodiment of the present disclosure will be described with reference to FIGS. 8 and 9.

FIGS. 8 and 9 are side views showing an ink storage container according to an embodiment of the present disclosure.

In the present embodiment, as shown in FIGS. 8 and 9, a constricted part 802 and another constricted part 804 are provided in an ink storage portion 200 of an ink storage container 100. In the present embodiment, the constricted parts 802 and 804 are provided at a boundary 806 between a main body region 216 and a first region and a boundary 808 between the main body region 216 and a second region, respectively. The present embodiment will be described in detail below.

In a first example shown in FIG. 8, the constricted parts 802 and 804 are provided near the boundary 806 between a first region 212 and the main body region 216 of the ink storage container 100 and the boundary 808 between a second region 214 and the main body region 216, respectively. Particularly, in the first example shown in FIG. 8, the constricted parts 802 and 804 can be partially provided so as to enter into the first region 212 and the second region 214 beyond the boundaries 806 and 808. That is, in the embodiment shown in FIG. 8, a large portion of the constricted part 802 is located inside the first region 212, and a large portion of the constricted part 804 is located inside the second region 214. Here, in the first example, the “large portion” denotes that more than or equal to 70% and less than 90% of the constricted parts 802 and 804 are located inside the first region 212 or the second region 214. In the present embodiment, large portions of the constricted parts 802 and 804 are located in the first region 212 or the second region 214 formed solely of a fossil fuel-derived resin. In other words, the boundaries 806 and 808 between the main body region 216 and the first and second regions 212 and 214 are located at the second end portion side of the constricted part 802 and the first end portion side of the constricted part 804, respectively (FIG. 8).

With this configuration, the ink storage portion 216 can be cut and divided within the first region or the second region where the constricted parts 802 and 804 are located. For example, the first region 212 consisting only of the fossil fuel-derived resin can be reliably separated from the ink storage portion by cutting and separating the first region 212 at the center of the constricted part 802 near the first end portion 206. Similarly, the second region 214 consisting only of the fossil fuel-derived resin can be reliably separated from the ink storage portion by cutting and separating the second region 214 at the center of the constricted part 804 near the second end portion 208. In this way, the ink storage container 100 can be divided into two parts: a first part of the first and second regions consisting only of the fossil fuel-derived resin, and a second part of the other region containing both the fossil fuel-derived resin and biomass-derived resin.

In the present embodiment, the shape of the constricted part is not particularly limited. As seen from the side of the ink storage container 100, the shape of the constricted part can be semicircular, semielliptical, triangular, rectangular, trapezoidal, or the like.

Next, a second example of the fourth embodiment will be described. In the second example, as shown in FIG. 9, constricted parts 802 and 804 are provided near the boundary 806 between the first region 212 and the main body region 216 of the ink storage container 100 and the boundary 808 between the second region 214 and the main body region 216 thereof. Particularly, the second example differs from the first example shown in FIG. 8 in that the constricted parts 802 and 804 are partially provided so as to enter into the main body region 216 beyond the boundaries 806 and 808. That is, as shown in FIG. 9, large portions of the constricted parts 802 and 804 are located inside the main body region 216. Here, in the second example, the “large portion” denotes that more than or equal to 70% and less than 90% of the constricted parts 802 and 804 are located on the main body region 216 side adjacent to the first region and the second region, respectively. In the present embodiment, the large portions of the constricted parts are located in the main body region 216 formed of a material containing a biomass-derived resin. In other words, the boundaries 806 and 808 between the main body region 216 and the first and second regions 212 and 214 are located at the first end portion side of the constricted part 802 and the second end portion side of the constricted part 804, respectively (FIG. 9).

With this configuration, the ink storage portion 200 can be cut and divided within the main body region where the constricted parts 802 and 804 are located. For example, the main body region 216 consisting only of the material containing the biomass-derived resin can be reliably separated from the ink storage portion by cutting and separating the main body region at the center of the constricted part 802 within the main body region. The same applies to the constricted part 804. In this way, the ink storage container 100 can be divided into two parts: a first part of the main body region 216 consisting only of the material containing the biomass-derived resin, and a second part of the first and second regions containing both the fossil fuel-derived resin and the biomass-derived resin.

In the second example of the fourth embodiment, again, the configuration, shapes, characteristics, and the like other than those described above are as described in the first example of the fourth embodiment.

In the above description of the fourth embodiment, the ink storage portion has the first and second regions and the main body region of the first embodiment. However, the constricted parts described in the present embodiment can also be provided in the second and third embodiments. That is, the constricted parts can also be applied to the ink storage portion having the first or second region and the main body region, as in the second and third embodiments. In a case of these embodiments, constricted parts as described above may be provided at the boundary between the first region and the main body region, or at the boundary between the second region and the main body region.

In the present embodiment, the ink storage container 100 can have a compatible portion, and at least one of the constricted parts 802 and 804 can be the compatible portion. At least one of the fossil fuel-derived resin and the biomass-derived resin can be colored, and at least one of the constricted parts 802 and 804 can be colored so as to be distinguishable from other portions, such as the ink storage portion.

A method for manufacturing an ink storage container in the fourth embodiment is the same as the method for manufacturing an ink storage container in the first to third embodiments, except that a constricted part is formed at the boundary between either the first region or the second region and the main body region in the ink storage portion. The method for manufacturing an ink storage container in the fourth embodiment is the same as the method for manufacturing an ink storage container in the first to third embodiments, except that constricted parts are formed at the boundaries between both the first and second regions and the main body region in the ink storage portion.

According to the present embodiment, compared to the first embodiment, the ink storage container 100 can be separated into a portion consisting only of each resin and a portion containing a mixture of the resins, allowing for efficient reuse of the resins. Other configurations and effects of the present embodiment are the same as those of the first embodiment, and description is incorporated herein by reference.

As described above, the environmental burden can be reduced, to contribute to the realization of a sustainable society, such as a decarbonized/recycling society.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The present disclosure provides an ink storage container made of biomass plastics, having improved strength against impacts such as fall of the ink storage container.

This application claims the benefit of Japanese Patent Application No. 2024-218848, filed Dec. 13, 2024, which is hereby incorporated by reference herein in its entirety.

What is claimed is:

1. An ink storage container for supplying ink to an ink ejection apparatus, the ink storage container comprising:
a storage portion; and
a pouring portion for pouring ink stored in the storage portion,
wherein the storage portion includes at least one of:
(a) a first region, a second region, and a main body region, with the main body region sandwiched between the first region and the second region,
(b) the first region and the main body region, or
(c) the second region and the main body region,
wherein the main body region contains a first resin derived from biomass, and
wherein the first region and the second region are made of a second resin derived from fossil fuel.

2. The ink storage container according to claim 1, wherein the first resin of the main body region is more than or equal to 10 mass %, based on a total mass of the ink storage container.

3. The ink storage container according to claim 1, wherein:
the storage portion further includes a first end portion on a same end as the pouring portion, a second end portion on an opposite end from the first end portion, and a side region between the first end portion and the second end portion,
the first region extends from the first end portion toward the main body region, within the side region, and
the second region extends from the second end portion toward the main body region, within the side region.

4. The ink storage container according to claim 1, wherein the storage portion has a compatible portion in which the first resin of the main body region is mixed with the second resin of the first region or the second resin of the second region.

5. The ink storage container according to claim 1, wherein an impact strength of the second resin is higher than an impact strength of the first resin.

6. The ink storage container according to claim 1, wherein:
one of the first resin or the second resin is colored, or
the first resin and the second resin are both colored, in different colors.

7. The ink storage container according to claim 1, wherein:
the storage portion includes the main body region and one of the first region or the second region, and
in a case where the storage portion comprises the main body region and the first region, a height of the first region, measured from the first end portion, is less than or equal to 45% of a total height of the storage portion.

8. The ink storage container according to claim 1, wherein:
the storage portion includes the main body region and one of the first region or the second region, and
in a case where the storage portion comprises the main body region and the second region, a height of the second region, measured from the second end portion, is less than or equal to 45% of a total height of the storage portion.

9. The ink storage container according to claim 1, wherein:
the storage portion further includes a first end portion on a same end as the pouring portion, a second end portion on an opposite end from the first end portion, and a side region between the first end portion and the second end portion,
the storage portion comprises the main body region within the side region and one of the first region or the second region within the side region, and
in a case where the storage portion comprises the main body region and the first region, a height of the first region, measured from the first end portion, is more than or equal to 50% of a total height of the storage portion.

10. The ink storage container according to claim 1, wherein:
the storage portion further includes a first end portion on a same end as the pouring portion, a second end portion on an opposite end from the first end portion, and a side region between the first end portion and the second end portion,
the storage portion comprises the main body region within the side region and one of the first region or the second region within the side region, and
in a case where the storage portion comprises the main body region and the second region, a height of the second region, measured from the second end portion, is more than or equal to 50% of a total height of the storage portion.

11. The ink storage container according to claim 1, wherein the storage portion has a constricted part at at least one of a boundary between the main body region and the first region, and a boundary between the main body region and the second region.

12. A method for manufacturing an ink storage container having an storage portion and a pouring portion for pouring ink stored in the storage portion, the storage portion having a main body region containing a first resin derived from biomass and at least one of a first region and a second region made of a second resin derived from fossil-fuel,
the manufacturing method comprising:
forming the storage portion; and
forming the pouring portion,
wherein forming the storage portion comprises at least one of forming the main body region and the first region, forming the main body region and the second region, or forming the main body region, the first region, and the second region.

13. The method for manufacturing the ink storage container according to claim 12, wherein the storage portion is formed by two-color molding.

14. The method for manufacturing the ink storage container according to claim 12, wherein the storage portion is formed by welding.
